(19) United States
(12) Patent Application Publication
(10) Pub. No.: US 2021/0163773 A1
(43) Pub. Date: Jun. 3, 2021

(54) FLUID SETS

(71) Applicant: Hewlett-Packard Development Company,L.P., Spring, TX (US)

(72) Inventors: Zhang-Lin ZHOU, San Diego, CA (US); Qianhan YANG, San Diego, CA (US)

(73) Assignee: Hewlett-Packard Development Company, L.P., Spring, TX (US)

(21) Appl. No.: 17/267,090

(22) PCT Filed: Dec. 18, 2018
(86) PCT No.: PCT/US2018/066182

§ 371 Date: Feb. 9, 2021

(51) Int. Cl. C09D 11/54; C09D 11/322; C09D 11/104; B41M 5/00; D06P 5/30

(52) U.S. Cl. CPC C09D 11/54; C09D 11/322; C09D 11/104; D06P 5/30; B41M 5/0047; B41M 5/0064; B41M 5/0023

(57) ABSTRACT

A fluid set can include an ink composition including water, organic co-solvent, pigment having dispersant associated with or attached thereto, and from 0.5 wt % to 20 wt % of polymer binder particles selected from polyurethane particles including a polyurethane polymer with sulfonated amine groups, or polyurethane-latex hybrid particles. The fluid set can also include a crosslinker composition including water, organic co-solvent, and from 2 wt % to 10 wt % polycarbodiimide.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc. However, the permanence of printed ink on textiles can be an issue, such as when using aqueous inks on fabric substrates.

### BRIEF DESCRIPTION OF DRAWINGS

FIG. 1 schematically represents an example fluid set, including an ink composition with various types of binder particles, and a crosslinker composition with a polycarbodiimide in accordance with the present disclosure;

FIG. 2 schematically illustrates an example preparation of polyurethane-latex hybrid particles that can be used in an example ink composition in accordance with the present disclosure;

FIG. 3 schematically depicts an example textile printing system that includes an ink composition, a crosslinker composition, and a fabric substrate; and

FIG. 4 depicts an example method of textile printing in accordance with the present disclosure.

### DETAILED DESCRIPTION

Digital printing on fabric can be carried out using ink compositions and crosslinker compositions, printed in contact on the fabric. These compositions, in one example, can even be suitable for digital printing using thermal inkjet printing technology, which is typically a less expensing ejection technology than piezoelectric printing. Furthermore, the ink compositions can also have good stability, jettability, color gamut, washfastness (durability through fabric washing cycles when printed with the crosslinker compositions) on various fabrics, including cotton, polyester, nylon, silk, or combinations thereof, e.g., cotton/polyester blend.

In one example of the present disclosure, a fluid set includes an ink composition and crosslinker composition. The ink composition includes water, organic co-solvent, pigment having dispersant associated with or attached thereto, and from 0.5 wt % to 20 wt % of polymer binder particles selected from polyurethane particles including a polyurethane polymer with sulfonated amine groups, or polyurethane-latex hybrid particles. The crosslinker composition includes water, organic co-solvent, and from 2 wt % to 10 wt % polycarbodiimide. In one example, the polyurethane particles can be present and include nonionic diamine groups. The polyurethane particles can be present and have a weight average molecular weight from 30,000 Mw to 300,000 Mw, a D50 particle size from 20 nm to 300 nm, and an acid number from 0 mg KOH/g to 30 mg KOH/g. The polyurethane particles can likewise be present and include isocyanate-generated amino groups. The polyurethane particles or the polyurethane-latex hybrid particles can be present and include polyester-type polyurethane polymer. In still another example, the polyurethane-latex hybrid particles can be present in a core-shell arrangement with a 5 wt % to 30 wt % polyurethane shell having an acid number from 50 mg KOH/g to 110 mg KOH/g, and a 70 wt % to 95 wt % (meth)acrylic latex polymer core having a glass transition temperature from −30° C. to 50° C., wherein weight percentages of the polyurethane-latex hybrid particles is based on a total weight of the hybrid particles. The polycarbodiimide can be at from 3 wt % to 7 wt % in the crosslinker composition. In another example, a textile printing system includes an ink composition, a crosslinker composition, and a fabric substrate. The ink composition includes water, organic co-solvent, pigment having dispersant associated with or attached thereto, and from 0.5 wt % to 20 wt % of polymer binder particles selected from polyurethane particles including a polyurethane polymer with sulfonated amine groups, or polyurethane-latex hybrid particles. The crosslinker composition includes water, organic co-solvent, and from 2 wt % to 10 wt % polycarbodiimide. In one example, the polyurethane particles are present and further includes nonionic diamine groups. In another example, the polyurethane-latex hybrid particles are present in a core-shell arrangement with a 5 wt % to 30 wt % polyurethane shell having an acid number from 50 mg KOH/g to 110 mg KOH/g, and a 70 wt % to 95 wt % (meth)acrylic polymer core having a glass transition temperature from −30° C. to 50° C. The weight percentages of the polyurethane-latex hybrid particles are based on a total weight of the polyurethane-latex hybrid particles. In another example, the polyurethane-latex hybrid particles are present and include sulfonated- or carboxylated-polyurethane. In another example, fabric substrate includes cotton, polyester, nylon, silk, or a blend thereof.

In another example, a method of textile printing includes separately ejecting i) an ink composition and ii) a crosslinker composition, wherein after ejecting, the ink composition and the crosslinker composition are in contact on a fabric substrate. The ink composition includes water, organic co-solvent, pigment having dispersant associated with or attached thereto, and from 0.5 wt % to 20 wt % of polymer binder particles selected from polyurethane particles including a polyurethane polymer with sulfonated amine groups, or polyurethane-latex hybrid particles. The crosslinker composition includes water, organic co-solvent, and from 2 wt % to 10 wt % polycarbodiimide. In this example, when in contact on the fabric substrate, the polycarbodiimide and the polymer binder particles are combined at a weight ratio of 1:99 to 3:7. In one example, the fabric substrate includes cotton, polyester, nylon, silk, or a blend thereof. In still another example, curing the ink composition contacted with the crosslinker composition on the fabric substrate can occur at a temperature from 60° C. to 100° C. for from 30 seconds to 5 minutes.

It is noted that when discussing the fluid set, the textile printing system, or the method of textile printing, these discussions can be considered applicable to other examples whether or not they are explicitly discussed in the context of that example. Thus, for example, in discussing a pigment related to the ink composition, such disclosure is also relevant to and directly supported in context of the textile printing system or the method of textile printing, and vice versa.

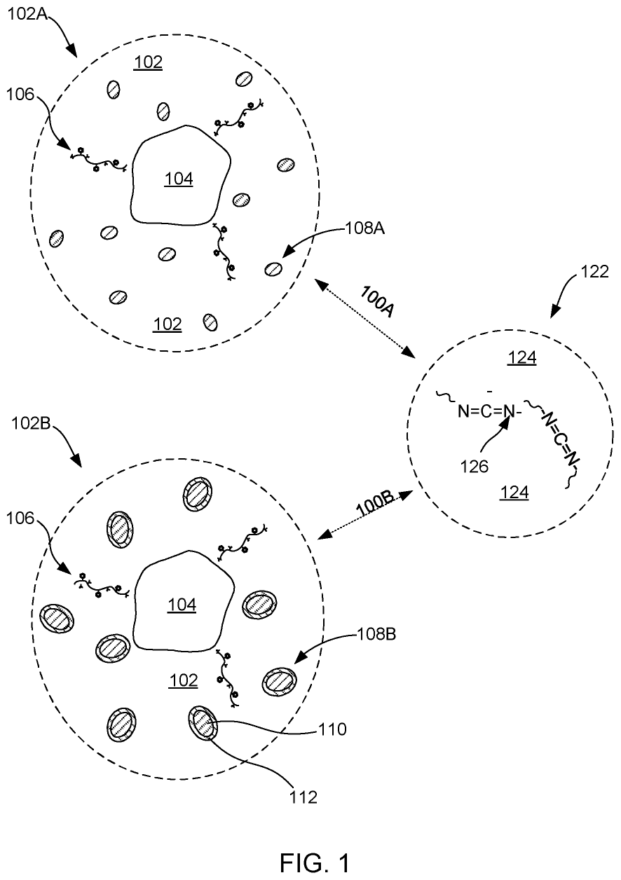

In accordance with this, the present disclosure is drawn a fluid set, shown at 100A or 100B in FIG. 1, which can include an ink composition (102A or 102B, respectively) and a crosslinker composition 122. The ink composition in both examples includes a liquid vehicle 102, which includes water and organic co-solvent, and pigment 104 having dispersant 106 associated with or attached thereto, and of polymer binder particles 108A and/or 1086. In one example, the polymer binder particles can include polyurethane particles 108A including polyurethane polymer with sulfonated amine groups, for example. In one example, the polyurethane can include isocyanate-generated amino groups and/or nonionic polyamine groups, for example. One example fluid set is shown at 100A, which includes the ink composition with polyurethane particles and the crosslinker composition. On the other hand, the fluid set can be as shown at 1006, where the polyurethane particles include polyurethane-latex hybrid particles 1086, with a latex (meth)acrylic polymer core 110 and a polyurethane shell 112. In both examples, the crosslinker composition can include a liquid vehicle 124 including water and organic co-solvent, for example, and from 2 wt % to 10 wt % polycarbodiimide 126.

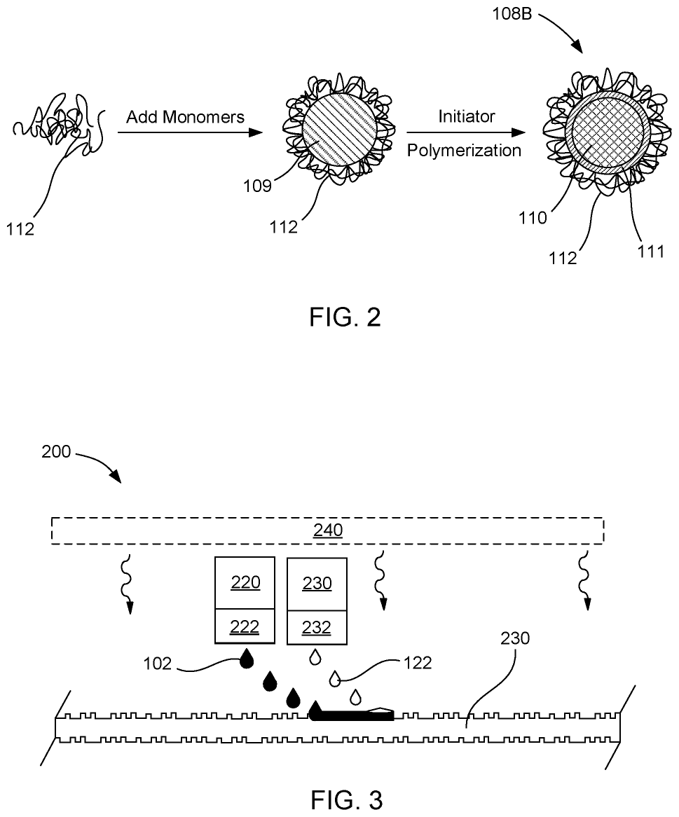

With more detail regarding the polyurethane-latex hybrid particles 108B shown as part of fluid set 1006, FIG. 2 provides an example preparative scheme for preparing these polyurethane-latex hybrid particles. In this example, the polyurethane 112 polymer can be prepared initially and then the monomers 109 for the (meth)acrylic latex polymer can be copolymerized in the presence of the polyurethane. Surfactant can be used in some examples, but in other examples, surfactant can be omitted because the polyurethane can have properties that allow it to act as an emulsifier for the emulsion polymerization reaction. Initiator can then be added to start the polymerization process, resulting in the polyurethane-latex hybrid particles 108, which includes a (meth)acrylic latex core 110, a polyurethane shell, and in further detail, there may also be a hybrid zone 111 therebetween where the polyurethane and latex polymer may co-exist.

In another example, a textile printing system, shown at 200 in FIG. 3, can include a fabric substrate 230, an ink composition 102, and an ink composition reservoir 220 that can be fluidly coupled or couplable to a fluid ejector 222, such as a thermal inkjet printhead to thermally eject the ink composition on the fabric substrate. The system can further include a crosslinker composition 122 and a crosslinker composition reservoir 230 that can be fluidly coupled or couplable to a fluid ejector 232, such as a thermal inkjet printhead to thermally eject the crosslinker composition on the fabric substrate. Furthermore, as with the FIG. 1 fluid sets, the ink composition in this example can include water, organic co-solvent, pigment having a dispersant associated with or attached to a surface thereof, and polymer binder particles, such as the polyurethane particles or the polyurethane-latex hybrid particles, for example. Likewise, the crosslinker composition can include water and an organic solvent, and can further include a polycarbodiimide crosslinker dispersed or dissolved therein.

A heat curing device 240 can also be included to heat the ink composition 102 and the crosslinker composition 122 after application onto the fabric substrate 230. Though a range of heat profiles can be used to heat the ink composition and the crosslinker composition on the fabric substrate, e.g., 60° C. to 200° C. for 15 seconds to 5 minutes, in one example, these polymer binder particles (from the ink composition) and polycarbodiimide crosslinkers (from the crosslinker composition) can be cured at relatively low temperatures, e.g., from 60° C. to 100° C. for similar time periods. Thus, in some other examples, acceptable durability can occur at from 60° C. to 100° C., or from 70° C. to 90° C., for example. Higher temperatures can also be used in some examples, e.g., from 100° C. to 200° C., from 120° C. to 180° C., or from 130° C. to 170° C., for example. Curing times can be from 15 seconds to 5 minutes, from 30 seconds to 5 minutes, or from 1 minute to 4 minutes, for example. The heat curing device can provide energy to crosslink, for example, the polyurethane or the polyurethane shell of of the polyurethane-latex hybrid particles.

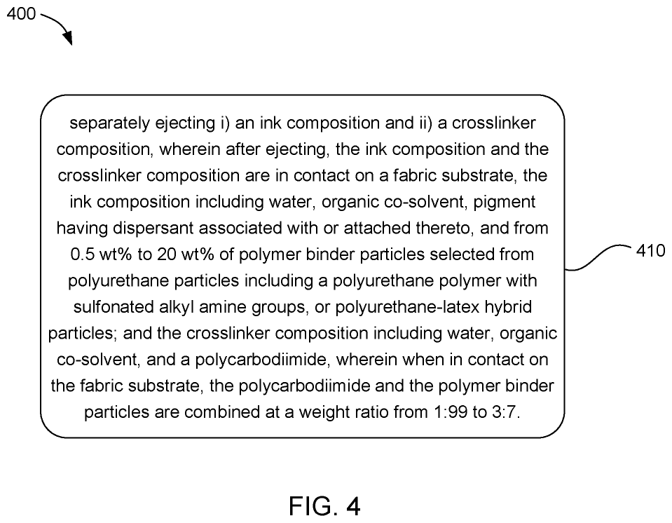

Using this fluid set on fabric substrates, durable images can be prepared. For example, the present disclosure also includes a method 400 of textile printing, shown in FIG. 4. The method can include separately ejecting 410 an ink composition and a crosslinker composition. After the ejections, the ink composition and the crosslinker composition are in contact on a fabric substrate. The ink composition can include water, organic co-solvent, pigment having dispersant associated with or attached thereto, and polymer binder particles. The polymer binder particles can include polyurethane particles and/or polyurethane-latex hybrid particles. The polyurethane polymer of the polyurethane particles include sulfonated amine groups. For example, the sulfonated amine group can be a sulfonated aliphatic polyamine group, or more specifically in one example, a sulfonated alkyl diamine group. An example of a polyurethane with a sulfonated alkyl diamine groups is Impranil® DLN-SD, available from Covestro (USA). The polyurethane polymer of the polyurethane particulates or of the polyurethane-latex hybrid particles can, in some examples, further include isocyanate-generated amino groups and/or nonionic diamines. Examples of polyurethanes with all three of these features, e.g., sulfonated alkyl diamine groups, isocyanate-generated amino groups, and nonionic diamines, can be prepared in accordance with Examples 1 and 2 herein, for example. In one example, the polyurethane-latex hybrid particles, if present, can be carboxylated or sulfonated. The crosslinker composition can include water, organic co-solvent, and a polycarbodiimide. When in contact on the fabric substrate, the polycarbodiimide and the polymer binder particles can be combined at a weight ratio from 1:99 to 3:7. The fabric substrate can include, for example, cotton, polyester, nylon, silk, or a blend thereof. Furthermore, curing the ink composition contacted with the crosslinker composition on the fabric substrate can occur at a temperature from 60° C. to 200° C. for 15 seconds to 5 minutes, or alternatively, in a low temperature application, curing can occur at from 60° C. to 100° C. for 30 seconds to 5 minutes.

Turning now to more detail regarding polyurethane polymer used to form the polyurethane particles, or the polyurethane polymer used in forming the polyurethane-latex hybrid particles, in one specific example, the polyurethane can include sulfonated amine groups. The polyurethane-latex hybrid particles may alternatively include carboxylates to provide polymer dispersion. Either type of polymer particle can include both sulfonated amine groups and carboxylates. In one example, the sulfonated amine can be a sulfonated aliphatic polyamine, e.g., sulfonated alkyl diamine. In other more detailed examples, the polyurethane can include isocyanate-generated amine groups, e.g., amino groups and/or secondary amine groups generated by molar excess of isocyanate groups not used in forming the polyurethane polymer precursor or grafting of other side groups thereon, e.g., nonionic diamine or other side groups that may utilize an isocyanate group to become attached to the polyurethane polymer backbone. In certain examples, polyurethane can also include nonionic diamine groups. The isocyanate-generated amine groups and the nonionic diamine groups may also both be present, and both may include an aliphatic groups therein.

With respect to the compounds, side groups, or reactants described herein as “aliphatic,” such as certain nonionic aliphatic diamines, this term includes straight-chain alkyl groups, branched-chain alkyl groups, or alicyclic groups, e.g., saturated C2 to C16 aliphatic groups, such as alkyl groups, alicyclic groups, combinations of alkyl and alicyclic groups. Example combinations can include straight-chain alkyl, branched-chain alkyl, alicyclic, branched-chain alkyl alicyclic, straight-chain alkyl alicyclic, alicyclic with multiple alkyl side chains, etc. With respect to compounds, side groups, or reactants described as “aromatic,” it is noted that they can include any of a number of aromatic moieties in addition to other moieties, e.g., amine group(s), and can further include methyl groups or other aliphatic moieties as defined above attached to the aromatic group. These definitions of “aliphatic” and “aromatic” with respect to the amines, for example, can be related to both the sulfonated polyamines or the nonionic polyamines described herein.

With respect to the “isocyanate-generated amine” groups, these types of groups can refer to amino or secondary amine groups that can be generated from excess isocyanate (NCO) groups that are not utilized when forming the polymer precursor. Thus, upon reacting with water (rather than being used to form the polymer backbone with a diol) the excess isocyanate groups release carbon dioxide, leaving an amine group where the isocyanate group was previously present. Thus, these amine groups are generated by the reaction of excess isocyanate groups with water to leave the isocyanate-generated amine groups, which can be along the polymer backbone, for example.

The “nonionic diamine” groups can likewise be present and reacted with a polymer precursor to form nonionic diamine groups as pendant side chains. These can also be aliphatic diamine groups. As mentioned in the context of the sulfonated amine groups, the term “aliphatic” refers to C2 to C16 aliphatic groups that can be saturated, but includes unsaturated aliphatic groups as well. Thus, the term “aliphatic” can be used similarly in the context of the nonionic diamine groups, and can include, for example, alkyl groups, alicyclic groups, combinations of alkyl and alicyclic groups, etc., and can include from C2 aliphatic to C16 aliphatic, e.g., straight-chain alkyl, branched alkyl, alicyclic, branched alkyl alicyclic, straight-chain alkyl alicyclic, alicyclic with multiple alkyl side chains, etc.

In further detail, the polyurethane particles (or polyurethane shell of hybrid particles), in one example, can include polyester polyurethane moieties. In still another example, the polyurethane can also further include a carboxylate group, such as carboxylate groups provided by carboxylate diols so that they can become polymerized directly as part of the polymer backbone of the polyurethane. Thus, in addition to diols that may be used to react with the isocyanate groups to form the urethane linkages, a carboxylated diol may likewise be used to react with the diisocyanates to add carboxylated acid groups along a backbone of the polyurethane polymer of the polyurethane particles (or polyurethane shell of hybrid particles).

In further detail, as mentioned, there can be various types of amine groups present on the polyurethane particles (or polyurethane shell of hybrid particles), namely sulfonated amine, e.g., diamine or other polyamine groups, isocyanate-generated amine groups, and nonionic diamine groups, for example. In one example, the isocyanate-generated amine groups can be present on the polyurethane at from 2 wt % to 8 wt % compared to a total weight polyurethane. In further detail, however, there can also be a third type of amine group present on the polyurethane, namely a nonionic diamine appended to the polyurethane.

As mentioned, the polyurethane particles (or polyurethane shell), can include multiple amines from various sources. For example, the polyurethane can include sulfonated amine groups as well as isocyanate-generated amine groups. The sulfonated amine groups can be reacted with a polymer precursor, resulting in some examples as a pendant side chain with one of the amine groups attaching the pendant side chain to a polymer backbone and the other amine group and sulfonate or carboxylate group being present along the pendant side chain. The isocyanate-generated amino group, on the other hand, can be generated from excess isocyanate (NCO) groups that are not utilized when forming the polymer precursor, as also mentioned. In further detail, however, there can also be a third type of amine present on the polyurethane of the present disclosure. In some examples, in addition to the sulfonated amine groups described above, and in addition to the isocyanate-generated amine groups, nonionic diamine groups can also be reacted with the polymer precursor to form nonionic diamine groups as pendant side chains. As mentioned in the context of the sulfonated amine groups, the term “aliphatic” refers to C2 to C16 aliphatic groups that can be saturated, but includes unsaturated aliphatic groups as well. Thus, the term “aliphatic” can be used similarly in the context of the nonionic diamine groups, and can include, for example, alkyl groups, alicyclic groups, combinations of alkyl and alicyclic groups, etc., and can include from C2 aliphatic to C16 aliphatic, e.g., straight-chain alkyl, branched alkyl, alicyclic, branched alkyl alicyclic, straight-chain alkyl alicyclic, alicyclic with multiple alkyl side chains, etc.

The polyurethane particles or the polyurethane-latex hybrid particles can have a D50 particle size from 20 nm to 300 nm, from 30 nm to 250 nm, from 40 nm to 200 nm, or from 50 nm to 150 nm. However, if the polyurethane is used to form a polyurethane shell of a hybrid particle, the polyurethane particle can be sized to generate the shell in combination with the (meth)acrylic latex core so that the total particle size is within the ranges described above, e.g., 20 nm to 300 nm, etc. Thus, for a polyurethane shell, the particle size can be form 5 nm to 100 nm, from 10 nm to 70 nm, or from 10 nm to 50 nm, for example, with the core having a D50 particle size from have a D50 particle size of 20 nm to 140 nm, from 40 nm to 130 nm, from 50 nm to 125 nm, or from 50 nm to 100 nm, for example. The weight average molecular weight of the polyurethane polymer of the polyurethane particles can be from 30,000 Mw to 300,000 Mw, as mentioned, but for the polyurethane-latex hybrid particles, the weight average molecular weight of the polyurethane polymer may be lower, e.g., from 1,000 Mw to 50,000 Mw, from 2,000 Mw to 40,000 Mw, or from 3,000 Mw to 30,000 Mw. The acid number of the polyurethane polymer for either the polyurethane particles or the polyurethane-latex hybrid particles can be from 0 mg KOH/g to 110 mg KOH/g, from 0 mg KOH/g to 50 mg KOH/g, from 0 mg KOH/g to 30 mg KOH/g, from 50 mg KOH/g to 110 mg KOH/g, for example. In further detail, the isocyanate group (NCO) to hydroxyl group (OH) molar ratio when forming the polyurethane can be such that there are excess NCO groups compared to the OH groups, such as provided by diols that may be used to form the polyurethane polymer. Thus, upon interaction with water, the excess NCO groups can liberate carbon dioxide and leave behind a secondary amine or an amino group which can participate in self-crosslinking, for example. Thus, in certain examples, the NCO to OH molar ratio can be from 1.1:1 to 1.5:1, from 1.15:1 to 1.45:1, or from 1.25 to 1.45, thus providing the isocyanate-generated amine groups described herein.

As an example, preparation of the polyurethane polymer used to form the polyurethane particles or the shell of the polyurethane-latex hybrid particles can include multiple steps, including pre-polymer synthesis which includes reaction of a diisocyanate with polymeric diol(s). The reaction can occur in the presence of a catalyst in acetone under reflux to give the pre-polymer, in one example. Other reactants may also be used in certain specific examples, such as organic acid diols (in addition to the polymeric diols) to generate acidic moieties along the backbone of the polyurethane polymer. In one specific example, the pre-polymer can be prepared with excess isocyanate groups that compared the molar concentration of the alcohol groups found on the polymeric diols or other diols that may be present. By retaining excess isocyanate groups, in the presence of water, the isocyanate groups can generate amino groups or secondary amines along the polyurethane chain, releasing carbon dioxide as a byproduct. This reaction can occur at the time of chain extension during the process of forming the polyurethane particles. Once the pre-polymer is formed, the polyurethane particles (or the polyurethane shell) can be generated by reacting the pre-polymer with sulfonated amines, and in some examples, also with nonionic diamines. Thus, the polyurethane can be crosslinked and/or can also include self-crosslinkable moieties. After formation, the solvent can then be removed by vacuum distillation, for example. If forming a polyurethane-latex hybrid copolymer, the polyurethane can be prepared in accordance with the example shown in FIG. 2.

Example diisocyanates that can be used to prepare the pre-polymer include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexane (H12MDI), etc., or combinations thereof, as shown below. Others can likewise be used alone, or in combination with these diisocyanates, or in combination with other diisocyanates not shown.

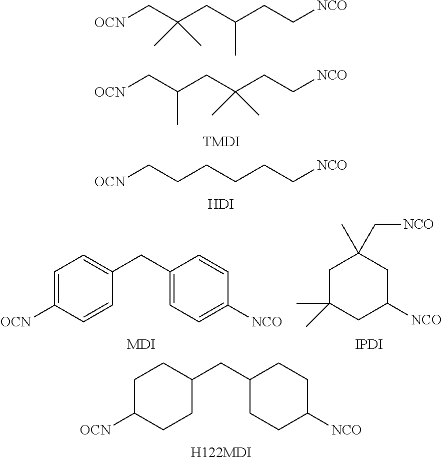

With respect to the polymeric diols that can be used, in one example, the polymeric diol can be a polyester diol, and in another example, the polymeric diol can be a polycarbonate diol, for example. Other diols that can be used include polyether diols, or even combination diols, such as would form a polycarbonate ester polyether-type polyurethane.

With respect to the various amines that can be used in forming the polyurethane as described herein, as mentioned, sulfonated amines as well as nonionic diamines can be used. Sulfonated amines can be prepared from diamines by adding carboxylate or sulfonate groups thereto. Nonionic diamines can be diamines that include aliphatic groups that are not charged, such as alkyl groups, alicyclic groups, etc. A charged diamine is not used for the nonionic diamine, if present. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc., oxalyl dihydrazides, azelaic dihydrazides, carbohydrazide, etc. It is noted however that these examples may not be appropriate for use for one or the other type of diamine, but rather, this list is provided as being inclusive of the types of diamines that can be used in forming sulfonated diamines and/or the non-ionic diamines, and not both in every instance (though some can be used for either type of diamine).

Example diamine structures are shown below. More specific examples of diamines include 4,4′-methylenebis(2-methylcyclohexyl-amine) (DMDC), 4-methyl-1,3′-cyclohexanediamine (HTDA), 4,4′-Methylenebis(cyclohexylamine) (PACM), isphorone diamine (IPDA), tetramethylethylenediamine (TMDA), ethylene diamine (DEA), 1,4-cyclohexane diamine, 1,6-hexane diamine, hydrazine, adipic acid dihydrazide (AAD), carbohydrazide (CHD), and/or diethylene triamine (DETA), notably, DETA includes three amine groups, and thus, is a triamine. However, since it also includes 2 amines, it is considered to fall within the definition herein of “diamine,” meaning it includes two amine groups. In some instances, these may be referred to as “polyamines,” but both terms are intended to have the same meaning herein unless describing a specific compound that includes “diamine” in the nomenclature, for example. Many of the diamine structures shown below can be used as a nonionic diamine, such as the uncharged aliphatic diamines shown below. Likewise, many or all of the diamines shown below can be sulfonated for use as a sulfonated diamine.

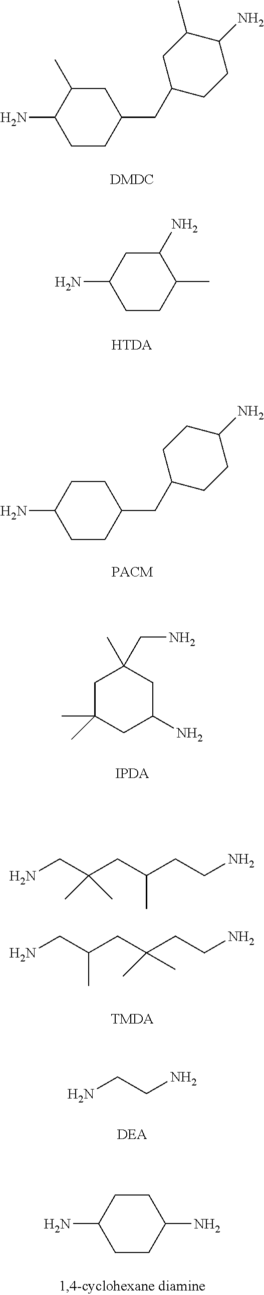

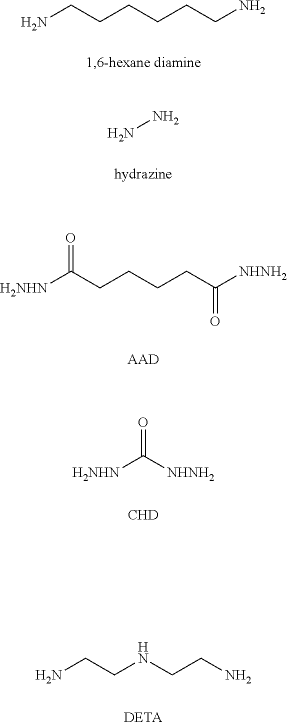

There are also other alkyl diamines (other than 1,6-hexane diamine) that can be used, such as, by way of example:

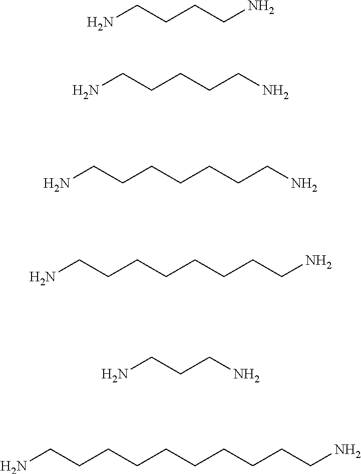 [SMILES: NCCCCN ; NCCCCCN ; NCCCCCCCN ; NCCCCCCCCN ; NCCCN ; NCCCCCCCCCCN]

There are also other dihydrazides (other than AAD shown above) that can be used, such as, by way of example:

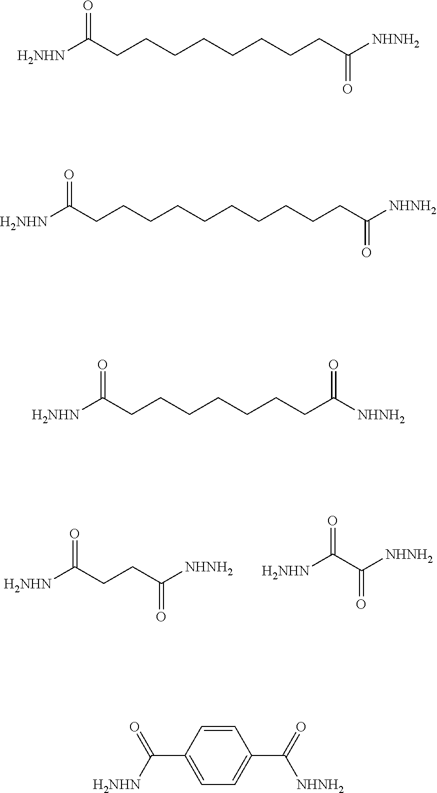

A few example sulfonated amines can be in the form of an aliphatic amine sulfonate, e.g., alkyl amine sulfonate, an alicyclic amine sulfonate, or an aliphatic alkyl amine sulfonate, (shown as a sulfonic acid, but as a sulfonate would include a positive counterion associated with an SO₃⁻ group). As another example, the sulfonate group could be replaced with a carboxylate group. An aliphatic amine sulfonate is shown by way of example in Formula I, as follows:

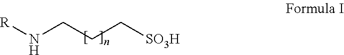

where R is H or is C1 to C10 straight- or branched-alkyl or alicyclic or combination of alkyl and alicyclic, and n is from 0 to 8, for example. Some specific examples of compounds that can be used in accordance with Formula I include the following:

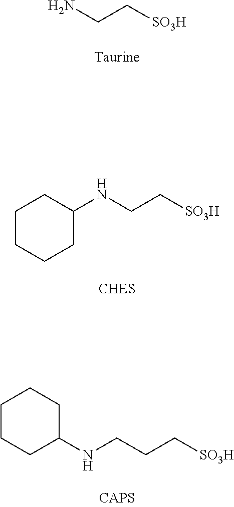 [SMILES: NCCS(=O)(=O)O ; O=S(=O)(O)CCNC1CCCCC1 ; O=S(=O)(O)CCCNC1CCCCC1]

Other examples can include sulfonated diamines, such as alkyl amine-alkyl amine-sulfonate as shown in Formula II below. Again, this formula is as a sulfonic acid, but as a sulfonate would include a positive counterion associated with an SO₃⁻ group, or alternatively could be a carboxylate with a counterion, for example). Furthermore, there can be others including those based on many of the diamine structures shown and described above.

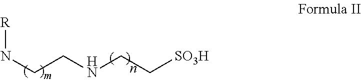

where R is H or is C1 to C10 straight- or branched-alkyl or alicyclic or combination of alkyl and alicyclic, m is 1 to 5, and n is 1 to 5. One example of such a structure sold by Evonik Industries (USA) is A-95, which is exemplified where R is H, m is 1, and n is 1. Another example structure sold by Evonik Industries is Vestamin®, where R is H, m is 1, and n is 2.

In accordance with an example of the present disclosure, if forming polyurethane-latex hybrid particles, after a polyurethane dispersion is prepared, the polyurethane can be present during the emulsion polymerization of any of a number of latex monomers to form the polyurethane-latex hybrid dispersion or particles. The latex monomers can include (meth)acrylic monomers, in some instances without added or additional surfactants. Example monomers that can be used include (meth)acrylates, such as mono(meth)acrylates, di(meth)acrylates, or polyfunctional alkoxylated or polyalkoxylated (meth)acrylic monomers including one or more di- or tri-(meth)acrylate. Example mono(meth)acrylates include cyclohexyl acrylate, 2-ethoxy ethyl acrylate, 2-methoxy ethyl acrylate, 2(2-ethoxyethoxy)ethyl acrylate, stearyl acrylate, tetrahydrofurfuryl acrylate, octyl acrylate, lauryl acrylate, behenyl acrylate, 2-phenoxy ethyl acrylate, tertiary butyl acrylate, glycidyl acrylate, isodecyl acrylate, benzyl acrylate, hexyl acrylate, isooctyl acrylate, isobornyl acrylate, butanediol monoacrylate, ethoxylated phenol monoacrylate, oxyethylated phenol acrylate, monomethoxy hexanediol acrylate, beta-carboxy ethyl acrylate, dicyclopentyl acrylate, carbonyl acrylate, octyl decyl acrylate, ethoxylated nonylphenol acrylate, hydroxyethyl acrylate, hydroxyethyl methacrylate, or the like. Example polyfunctional alkoxylated or polyalkoxylated (meth)acrylates include alkoxylated, ethoxylated, or propoxylated, variants of the following: neopentyl glycol diacrylates, butanediol diacrylates, trimethylolpropane triacrylates, glyceryl triacrylates, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, polybutanediol diacrylate, polyethylene glycol diacrylate, propoxylated neopentyl glycol diacrylate, ethoxylated neopentyl glycol diacrylate, polybutadiene diacrylate, and the like. In one more specific example, the monomer can be a propoxylated neopentyl glycol diacrylate, such as, for example, SR-9003 (Sartomer Co., Inc., Exton, Pa.). Example reactive monomers are likewise commercially available from, for example, Sartomer Co., Inc., Henkel Corp., Radcure Specialties, and the like.

Again, if preparing polyurethane-latex hybrid particles, the reaction medium for preparing the latex core can utilize both a charge stabilizing agent and an emulsifier in order to obtain a target particle size. Various charge stabilizing agents can be suitable for use in preparing the polyurethane-latex hybrid particles of the present compositions. In one example, the charge stabilizing agent can include methacrylic acid, acrylic acid, and/or a salt thereof. Sodium salts of methacrylic acid and/or acrylic acid can likewise be used in generating the (meth)acrylic latex core in the presence of the polyurethane dispersion (which forms the shell). The charge stabilizing agent may be used, for example, at from 0.1 wt % to about 5 wt % of the emulsion polymerization components. Various emulsion polymerization emulsifiers can be used, such as fatty acid ether sulfates, lauryl ether sulfate, etc. The emulsifier can be included in amounts such as 0.1 wt % to about 5 wt % by weight of the emulsion polymerization components. The emulsifier can be included not only to obtain the desired particle size of the (meth)acrylic latex core, but further to obtain a desired surface tension of the latex core in the range of from 40 dynes/cm to 60 dynes/cm, for example. In one example, the (meth)acrylic latex core can have a surface tension of from 45 dynes/cm to 55 dynes/cm. The emulsion polymerization can be carried out as a semi-batch process in some examples.

The (meth)acrylic latex core can be synthesized by free radical initiated polymerization, and any of a number of free radical initiator can be used accordingly. In one example, the initiator can include a diazo compound, a persulfate, a per-oxygen, or the like. For example, thermal initiators can be used that include azo compounds, such as 1,1′-azobis(cyclohexanecarbonitrile) 98 wt %, azobisisobutyronitrile 12 wt % in acetone, 2,2′-azobis(2-methylpropionitrile) 98 wt %, 2,2′-azobis(2-methylpropionitrile) recrystallized, 99 wt %; inorganic peroxides, such as ammonium persulfate reagent grade, 98 wt %; hydroxymethanesulfinic acid monosodium salt dihydrate; potassium persulfate ACS reagent, ≥99.0 wt %; sodium persulfate reagent grade, ≥98 wt %; dicumyl peroxide 98 wt %; or organic peroxides such as tert-butyl hydroperoxide solution packed in FEP bottles, ˜5.5 M in decane (over molecular sieve 4 Å); tert-butyl hydroperoxide solution 5.0-6.0 M in nonane; tert-butyl peracetate solution 50 wt % in odorless mineral spirits; cumene hydroperoxide technical grade, 80 wt %; 2,5-di(tert-butylperoxy)-2,5-dimethyl-3-hexyne, blend; Luperox® 101 (from Arkema, France), 2,5-bis(tert-butylperoxy)-2,5-dimethylhexane technical grade, 90 wt %; Luperox® 101XL45, 2,5-bis(tert-butylperoxy)-2,5-dimethylhexane, blend with calcium carbonate and silica; Luperox® 224, 2,4-pentanedione peroxide solution ˜34 wt % in 4-hydroxy-4-methyl-2-pentanone and N-methyl-2-pyrrolidone; Luperox® 231, 1,1-bis(tert-butylperoxy)-3,3,5-trimethylcyclohexane 92 wt %; Luperox® 331M80, 1,1-bis(tert-butylperoxy)cyclohexane solution ˜80 wt % in odorless mineral spirits; Luperox® 531M80, 1,1-bis(tert-amylperoxy)cyclohexane solution 80 wt % in odorless mineral spirits; Luperox® A70S, benzoyl peroxide 70 wt %, remainder water; Luperox® A75, benzoyl peroxide 75 wt %, remainder water; Luperox® A75FP, benzoyl peroxide, 75 wt % remainder water contains 25 wt % water as stabilizer, 75 wt %; Luperox® A75FP, benzoyl peroxide, 75 wt % remainder water contains 25 wt % water as stabilizer, 75 wt %; Luperox® A98, benzoyl peroxide reagent grade, ≥98 wt %; Luperox® AFR40, benzoyl peroxide solution 40 wt % in dibutyl phthalate; Luperox® ATC50, benzoyl peroxide ˜50 wt % in tricresyl phosphate; Luperox® DDM-9, 2-butanone peroxide solution ˜35 wt % in 2,2,4-trimethyl-1,3-pentanediol diisobutyrate; Luperox® DHD-9, 2-butanone peroxide solution ˜32 wt % in phthalate-free plasticizer mixture; Luperox® DI, tert-butyl peroxide 98 wt %; Luperox® P, tert-butyl peroxybenzoate 98 wt %; Luperox® TBEC, tert-butylperoxy 2-ethylhexyl carbonate 95 wt %; Luperox® TBH70X, tert-butyl hydroperoxide solution 70 wt % in H2O. Persulfate initiators such as ammonium persulfate are particularly preferred. The initiator may be included, for example, at from 0.01 wt % to 5 wt %, based on the weight of the emulsion polymerization components.

The (meth)acrylic latex core can have a glass transition temperature (Tg) from about −30° C. to 50° C., from about −15° C. to 35° C., or from about −5° C. to 35° C. This can contribute to the low curing temperatures described herein, e.g., from 60° C. to 100° C., in some examples. In some examples weight average molecular weight of the (meth)acrylic latex core can be from 50,000 Mw to 750,000 Mw, from 50,000 Mw to 600,000 Mw, from 50,000 Mw to 550,000 Mw, from 50,000 Mw to 450,000 Mw, or from 50,000 Mw to 400,000 Mw, or from 75,000 Mw to 750,000 Mw, from 100,000 Mw to 600,000 Mw, or from 200,000 Mw to 550,000 Mw. Molecular weight ranges outside of these ranges can be used. In further detail, the (meth)acrylic latex core can be uncrosslinked, which in some cases can provide comparable durability to crosslinked (meth)acrylic latex cores, which are also included as being usable in accordance with examples of the present disclosure. The term “uncrosslinked” means that the polymer chains are devoid of chemical crosslinkers or crosslinking groups that connect individual polymer strands to one another, which can partially contribute to lower glass transition temperatures in some examples. The term “crosslinked” refers to polymer strands that are interconnected with crosslinking agent or crosslinking groups. Both can be used in accordance with examples of the present disclosure.

Once formed, polyurethane-latex hybrid particles (with the shell applied to the (meth)acrylic latex core) can have a particle size from 30 nm to 300 nm, form 50 nm to 150 nm, or from 60 nm to 150 nm, from 75 nm to 150 nm, from 90 nm to 150 nm, from 50 nm to 140 nm, from 75 nm to 140 nm, or from 90 nm to 140 nm, for example. The weight ratio of polyurethane shell to (meth)acrylic latex core can be from 1:19 to 3:7, from 1:10 to 3:7, or from 1:9 to 1:4, from 1:9: to 3:17, or from 3:22 to 7:43, for example. The polyurethane-latex hybrid particles can have a glass transition temperature from −30° C. to 50° C., from −20° C. to 50° C., from −20° C. to 35° C., or from 0° C. to 50° C., for example. Glass transition temperature of the hybrid particles, including both the core and the shell copolymers, can be calculated using the Fox equation, as described herein.

Turning now to the crosslinking composition, as mentioned, the crosslinking composition can include water, organic co-solvent, and a polycarbodiimide crosslinker. The polycarbodiimide, for example, can be present in the crosslinker composition at from 2 wt % to 10 wt %, form 3 wt % to 9 wt %, from 4 wt % to 8 wt %, or from 5 wt % to 7 wt %. The polycarbodiimide can further have a weight average molecular weight of from 1,000 Mw to 100,000 Mw, from 1,000 Mw to 75,000 Mw, from 1,000 Mw to 50,000 Mw, from 2,000 Mw to 100,000 Mw, from 2,000 Mw to 50,000 Mw, from 5,000 Mw to 100,000 Mw, from 5,000 Mw to 50,000 Mw, from 5,000 Mw 40,000 Mw, from 5,000 Mw to 30,000 Mw, or from 5,000 Mw to 20,000 Mw, for example. These crosslinking polymers can be aliphatic and/or aromatic polymers, and can include heteroatoms that do not impact the nature of multiple imine-type groups of the polymer, as outlined previously.

A The general structure for a polycarbodiimide is shown below in Formula III, as follows:

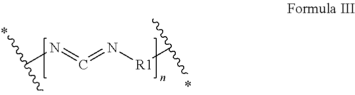

wherein R along the crosslinking polymer chain independently includes C1 to C15 alkyl, C3 to C15 alicyclic, C5 to C15 aromatic, heteroatom substitutes thereof, or a combination thereof. A heteroatom substitute, if present, is not directly attached to the nitrogen or the carbon of the imine group. The balance of the crosslinking polymer notated by an asterisk (*) indicates a continuation of the crosslinking polymer. The crosslinking polymer may include other groups not specifically indicated in Formula III, such as urethane groups, carbodiimide groups, etc. The variable “n” in this example is an integer from 2 to 1,000, from 4 to 500, or from 10 to 250, for example. Furthermore, Formula III does not infer that the imide group and other constituents between the brackets repeats consecutively, as there is typically a carbon atom on either side of the bracketed group shown. Formula III also does not infer that the R groups would be identical to one another within one polymeric unit within the bracket, nor does it infer that the R groups would be identical at the various polymeric units along the polymer chain, though they may be in one example.

The polycarbodiimide can, as mentioned, include other components or even other polymer types copolymerized therewith. For example, polycarbodiimides can include urethane caps and/or polyurethane portions. A general structure for an example hybrid polycarbodiimide is shown in Formula IV, as follows:

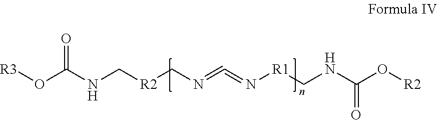

wherein R1-R4 along the crosslinking polymer chain can independently be or include C1 to C15 alkyl, C3 to C15 alicyclic, C5 to C15 aromatic, heteroatom substitutes thereof, or a combination thereof. Furthermore, R2-R4 can also independently be or include a urethane group and/or a carbodiimide group. The variable “n” in this example is an integer from 2 to 1,000, from 4 to 500, or from 10 to 250, for example.

Considering in further detail polycarbodiimides in particular as an example, as mentioned, these crosslinking polymers include multiple carbodiimide reactive groups, e.g., an average of 2 or more carbodiimide groups. However, as mentioned, they can also be combined with other functional reactive groups. Thus, there are multifunctional water-dispersible polycarbodiimides that provide high levels of crosslinking.

Non-limiting examples of polycarbodiimides that can be used for the crosslinking polymer include Carbodilite® polymers from Nasshinbo (Japan), such as Carbodilite® SV-02, V-02, V-02-L2, and/or E-02. Particularly, Carbodilite® SV-02 polycarbodiimides. Other examples of polycarbodiimides that can be used include Picassian® polymers from Stahl Polymers (USA) such as Picassian® XL-702 and Picassian® XL-732.

Turning to further detail regarding other components of the ink compositions or crosslinker compositions that can be used for the systems and methods described herein, the liquid vehicle, which can include the water, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %, can be formulated for ejection from fluid ejectors, for example. Other liquid vehicle components can also be included, such as surfactant, antibacterial agent, other colorant, etc. However, as part of the ink composition used in the systems and methods described herein, the pigment, dispersant, and the polyurethane can be included or carried by the liquid vehicle components.

In further detail regarding the liquid vehicle that can be used for the ink compositions and the crosslinker compositions herein, both can include water and organic co-solvent. The co-solvent(s) can be present and can include any co-solvent or combination of co-solvents that is compatible with the pigment, dispersant, and polyurethane-latex hybrid particles. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant and/or emulsifier. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives used to modify properties of the ink composition and/or the crosslinker composition

With specific reference to the ink compositions, the colorant selected for use can include a pigment, which can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow SGT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue −1, −2, −3, −15, −15:1, −15:2, −15:3, −15:4, −16, −22, and −60; magenta color pigment may include C.I. Pigment Red −5, −7, −12, −48, −48:1, −57, −112, −122, −123, −146, −168, −177, −184, −202, and C.I. Pigment Violet−19; yellow pigment may include C.I. Pigment Yellow −1, −2, −3, −12, −13, −14, −16, −17, −73, −74, −75, −83, −93, −95, −97, −98, −114, −128, −129, −138, −151, −154, and −180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC Corporation, CABOJET® 250C cyan pigment dispersion from Cabot Corporation (USA), 17-SE-126 cyan pigment dispersion from Dom Pedro, HPF-M046 magenta pigment dispersion from DIC Corporation, CABOJET® 265M magenta pigment dispersion from Cabot Corporation, HPJ-Y001 yellow pigment dispersion from DIC Corporation, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, or about 214, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The term “(meth)acrylate” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylate or a (meth)acrylic acid should not be read so rigidly as to not consider relative pH levels, ester chemistry, and other general organic chemistry concepts.

The textile printing systems and methods described herein can be suitable for printing on many types of textiles, such as cotton fibers, including treated and untreated cotton substrates, polyester substrates, nylons, blended substrates thereof, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

As mentioned, in some examples, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

It is notable that the term “fabric substrate” or “fabric media substrate” does not include materials such as any paper (even though paper can include multiple types of natural and synthetic fibers or mixtures of both types of fibers). Fabric substrates can include textiles in filament form, textiles in the form of fabric material, or textiles in the form of fabric that has been crafted into a finished article, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

The fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). By measuring OD and/or L*a*b* both before and after washing, ΔOD and ΔE values can be determined, which can be a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modified to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of about 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used.

When inks printed on various types of fabrics, e.g., cotton, nylon, polyester, cotton/polyester blend, etc., they were exposed to durability challenges, such as washfastness, e.g., five (5) standard washing machine cycles using warm water and a standard clothing detergent (e.g., Tide® available from Proctor and Gamble, Cincinnati, Ohio, USA), acceptable optical density retention of the printed inks can be the result. Additionally, these polyurethanes can also exhibit good stability over time as well as good thermal inkjet printhead performance such as high drop weight, high drop velocity, and acceptable “Turn On Energy” or TOE curve values, with some inks exhibiting good kogation.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the polyurethane particles, or the the polyurethane polyurethane shells and/or (meth)acrylic latex cores of the polyurethane-latex hybrid particles disclosed herein. This value can be determined, in one example, by dissolving or dispersing a known quantity of a material in organic solvent and then titrating with a solution of potassium hydroxide (KOH) of known concentration for measurement.

“Glass transition temperature” or “Tg,” can be calculated by the Fox equation: copolymer Tg=1/(Wa/(Tg A)+Wb(Tg B)+ . . . ) where Wa=weight fraction of monomer A in the copolymer and TgA is the homopolymer Tg value of monomer A, Wb=weight fraction of monomer B and TgB is the homopolymer Tg value of monomer B, etc. Thus, the glass transition temperature for the polyurethane polymer of the polyurethane particles or the polyurethane-latex hybrid particles, includes the polyurethane shell and/or the (meth)acrylic latex core.

“D50” particle size is defined as the particle size at which about half of the particles are larger than the D50 particle size and about half of the other particles are smaller than the D50 particle size (by weight based on the metal particle content of the particulate build material). As used herein, particle size with respect to the latex particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Preparation of Polyurethane Dispersion D1

72.410 grams of polyester diol (PED; Stepanol® PC-1015-55 from Stephan, USA), and 20.511 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. A condenser was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 4.109 grams of isophorone diamine (IPDA), 5.941 grams of a (sodium) sulfonated alkyl diamine (ADA), NH₂CH₂CH₂NHCH₂CH₂CH₂SO₃₋:Na⁺, at 50 wt % in water and 14.819 grams of deionized water were mixed in a beaker until the IPDA and the ADA was dissolved. The ADA is commercially available as A-95 by Evonik Industries, USA. The IPDA and ADA solution was added to the pre-polymer solution at 50° C. with vigorous stirring over 5 minutes. The solution became viscous and slightly hazy. The mixture continued to stir for 30 minutes at 50° C. Then cold 201.713 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 203.4 nm. The pH was 7. The solid content was 29.44 wt %.

### Example 2—Preparation of Polyurethane Dispersion D2

72.620 grams of polyester diol (PED; Stepanol® PC-1015-55 from Stephan, USA), and 20.570 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 3.830 grams of 2,2,4 (or 2, 4, 4)-trimethylhexane-1,6-diamine (TMDA), 5.941 grams of a (sodium) sulfonated alkyl diamine (ADA), NH₂CH₂CH₂NHCH₂CH₂CH₂SO₃⁻:Na⁺, at 50 wt % in water and 14.819 grams of deionized water were mixed in a beaker until the TMDA and the ADA was dissolved. The TMD and ADA solution was added to the pre-polymer solution at 50° C. with vigorous stirring over 5 minutes. The solution became viscous and slightly hazy. The mixture continued to stir for 30 minutes at 50° C. Then cold 201.713 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 156.8 nm. The pH was 7. The solids content was 34.5 wt %.

### Example 3—Preparation of Polyurethane Dispersions 1 (D3)

35.458 grams of grams of polytetrahydrofuran 1000 (PTMG), 35.467 grams of isophorone diisocyanate (IPDI), and 10.701 grams of 2,2-bis(hydroxymethyl)propionic acid (DMPA) in 42 grams of acetone were mixed in a 500 mL of 4-neck round bottom flask. A mechanical stirrer with glass rod and Teflon blade and a condenser was attached. The flask was immersed in a constant temperature bath at 60° C. The system was kept under drying tube. 3 drops of dibutyltin dilaurate (DBTDL) was added to initiate the polymerization. Polymerization was continued for 3 hours at 60° C. 0.5 gram sample was withdrawn for NCO titration to confirm the reaction. The measured NCO value was 4.35 wt %. Theoretical w % NCO should be 4.56%. The polymerization temperature was reduced to 40° C. 18.375 grams of 2-(cyclohexylamino)ethansesulfonic acid (CHES), 14.149 grams of 50% NaOH, and 45.937 grams of deionized water were mixed in a beaker until CHES were completely dissolved. The CHES solution was added to the pre-polymer solution at 40° C. with vigorous stirring over 1-3 minutes. The solution became viscous and slightly hazy. The mixture continued to be stir for 30 minutes at 40° C. The mixture became clear and viscous after 15-20 minutes at 40° C. 181.938 grams of deionized water was added to the polymer mixture in 4-neck round bottom flask over 1-3 minutes with good agitation to form the polyurethane (PUD) dispersion. The agitation was continued for 60 minutes at 40° C. The PUD dispersion was filtered through 400 mesh stainless sieve. Acetone was removed with a Rotorvap at 50° C., where 2 drops (20 mg) BYK-011 de-foaming agent was added. The final PUD dispersion was filtered through fiber glass filter paper. The D50 particle size was measured by a Malvern Zetasizer at 20.2 nm. The pH was 8.5. The solid content was 29.63 wt %.

### Example 4—Preparation of Polyurethane-Latex Hybrid Dispersion 1 (PULH1)

A suspension of Polyurethane prepared in accordance with Example 3 (D3) (43.874 g), sodium persulfate (SPS) (0.25 g), sodium dodecyl sulfate (SDS) (2.0 g), butyl acrylate (BA) (18.351 g), and methyl methacrylate (MMA) (76.225 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer at 118.8 nm. The pH was 7.5. The solid content was 34.24 wt %.

### Example 5—Preparation of Polyurethane-Latex Hybrid Dispersion 2 (PULH2)

A suspension of Polyurethane prepared in accordance with Example 3 (D3) (43.874 g), sodium persulfate (SPS) (0.25 g), sodium dodecyl sulfate (SDS) (2.0 g), methacrylamide (MAA) (1.692 g), butyl acrylate (BA) (18.351 g) and methyl methacrylate (MMA) (76.225 g) in deionized (DI) water (137 g) was well mixed with a high speed mixer for 2-3 hours. The suspension was transferred (via pump) into a three-neck flask equipped with a condenser thermometer and an N₂ inlet under an 80° C. water-bath within 3 hours, where the suspension was stirred at 85° C. for another 2 hours. The suspension was then cooled to room temperature and another 33 g of DI water was added. The suspension was then filtered through fiber glass filter paper. The D50 particle size measured by a Malvern Zetasizer was 125.2 nm. The pH was 7.5. The solid content was 32.65 wt %.

### Example 6—Preparation of Ink Compositions

An ink composition was prepared in accordance with the general formula shown in Table 1, as follows:

TABLE 1

| | | Magenta | Magenta |
|---|---|---|---|
| | | Ink 1 | Ink 2 |
| Ink ID | Category | (M1) | (M2) |
| Polyurethane | Polymer | — | 6 wt % |
| Dispersion | Binder | | |
| (D1—Example 1) | Particles | | |
| ¹Impranil ® | Polymer | 6 wt % | 6 wt % |
| DLN-SD | Binder | | |
| (Polyurethane | Particles | | |
| Dispersion) | | | |
| Glycerol | Organic | 6 wt % | 6 wt % |
| | Co-solvent | | |
| LEG-1 | Organic | 1 wt % | 1 wt % |
| | Co-solvent | | |
| ²Crodafos ® N3A | Surfactant | 0.5 wt % | 0.5 wt % |
| ³Surfynol ® 440 | Surfactant | 0.3 wt % | 0.3 wt % |
| ⁴Acticide ® B20 | Biocide | 0.22 wt % | 0.22 wt % |
| ⁵HPF-M046 | Colorant | 3 wt % | 3 wt % |
| Deionized Water | Solvent | Balance | Balance |

¹Impranil ® DLN-SD is available from Covestro (USA).
²Crodafos ™ N3A is available from Croda International Plc. (Great Britain).
³Surfynol ® 440 is available from Evonik, (Germany).
⁴Acticide ® B20 is available from Thor Specialties, Inc. (USA).
⁵HPF-M046 is a Magenta Pigment dispersed with styrene-acrylic polymer dispersant from DIC Corporation (Japan).

### Example 7—Preparation of Crosslinker Compositions

Seven different crosslinker compositions were prepared in accordance with the general formulas shown in Tables 2A and 2B, as follows:

TABLE 2A

| | | Crosslinker 1 |
|---|---|---|
| Crosslinker ID | Category | (XL1) |
| ⁶Carbodilite ® SV-02 | Polycarbodiimide Crosslinker | 6 wt % |
| Glycerol | Organic Co-solvent | 10 wt % |
| ³ Surfynol ® 440 | Surfactant | 0.3 wt % |
| Water | Solvent | balance |

⁶Carbodilite ® is available from Nasshinbo (Japan).
³ Surfynol ® 440 is available from Evonik, (Germany).

TABLE 2B

| | | Crosslinkers 2-7 |
|---|---|---|
| Crosslinker ID | Category | (XL1 to XL7) |
| ⁶Carbodilite ® SV-02 (XL2) | Polycarbodiimide | 6 wt % |
| Carbodilite ® V-02 (XL3) | Crosslinker | |
| Carbodilite ® V-02-L2 (XL4) | | |
| Carbodilite ® E-02 (XL5) | | |
| ⁷Picassian ® XL-702 (XL6) or | | |
| Picassian ® XL-732 (XL7) | | |
| 2-Pyrrolidinone | Organic Co-solvent | 10 wt % |
| ³Surfynol ® 440 | Surfactant | 0.3 wt % |
| Water | Solvent | balance |

⁵Carbodilite ® is available from Nasshinbo (Japan).
⁶Picassian ® is from Stahl Polymers (USA).
³Surfynol ® 440 is available from Evonik, (Germany).

### Example 8—Heat-Cured Ink Composition Durability on Fabric Substrates

Several prints were prepared by applying magenta ink composition durability plots at 3 dots per pixel (dpp) onto cotton, cotton/polyester blend, polyester/satin blend, or nylon fabrics, as notated in the respective tables below. Some of the samples were overprinted with 0.75 dpp, 1.5 dpp, or 2.25 dpp of a polycarbodiimide-based cross-linker composition, which included 6 wt % of a crosslinker compound (XL1-XL7), while other samples were not overprinted with the crosslinker composition. Furthermore, two different polyurethanes were evaluated, namely D1 polyurethanes were evaluated, which included sulfonated diamines, nonionic diamines, and isocyanate-generated amino groups; and Impranil® DLN-SD was also evaluated, which is sulfonated, but does not include excess isocyanate-generated aminos groups and nonionic diamines. After printing, the ink compositions were cured on the respective fabrics at 80° C. and 150° C. for 3 minutes. After curing, initial optical densities (OD) and L*a*b* values were recorded, the various printed fabrics were exposed to 5 washing machine complete wash cycles using conventional washing machines at 40° C. with detergent, e.g., Tide®, with air drying in between wash cycles. After 5 washes, the OD and L*a*b* were recorded a second time for comparison. Data collected is shown in Table 3 below.

TABLE 3
Durability of Magenta Ink Composition printed
and Heat-Cured on Cotton Gray Fabric Substrate

| | | 80° C. Curing | | | | 150° C. Curing | | | |
|---|---|---|---|---|---|---|---|---|---|
| | | Initial | OD 5 | | | Initial | OD 5 | | |
| Ink ID | Crosslinker ID | OD | wash | %ΔOD | ΔE_{CIE} | OD | wash | %ΔOD | ΔE_{CIE} |

Experiment 1 (Impranil ® DLN-SD Dispersion in Ink)

| | | | | | | | | | |
|---|---|---|---|---|---|---|---|---|---|
| M1 | None | 1.035 | 0.859 | −17.0 | 9.2 | 1.050 | 0.949 | −9.6 | 5.4 |
| M1 | 0.75 dpp XL1 | 1.026 | 0.953 | −7.3 | 4.7 | 1.027 | 0.981 | −4.5 | 2.5 |
| M1 | 0.75 dpp XL2 | 1.026 | 0.953 | −7.2 | 4.0 | 1.022 | 0.990 | −3.2 | 2.4 |

Experiment 2 (Impranil ® DLN-SD Dispersion in Ink)

| | | | | | | | | | |
|---|---|---|---|---|---|---|---|---|---|
| M1 | None | 1.028 | 0.834 | −18.8 | 7.3 | 1.044 | 0.955 | −8.5 | 4.1 |
| M1 | 0.75 dpp XL1 | 1.034 | 0.937 | −9.4 | 3.4 | 1.038 | 0.989 | −4.7 | 1.8 |
| M1 | 1.50 dpp XL1 | 1.045 | 0.927 | −11.3 | 3.5 | 1.041 | 1.002 | −3.7 | 2.2 |
| M1 | 2.25 dpp XL1 | 1.030 | 0.940 | −8.7 | 3.4 | 1.031 | 1.009 | −2.2 | 1.3 |
| M1 | 0.75 dpp XL2 | 1.032 | 0.965 | −6.5 | 2.8 | 1.040 | 1.021 | −1.9 | 1.5 |
| M1 | 1.50 dpp XL2 | 1.046 | 0.977 | −6.6 | 2.8 | 1.038 | 1.031 | −0.7 | 1.3 |
| M1 | 2.25 dpp XL2 | 1.036 | 0.989 | −4.6 | 2.0 | 1.035 | 1.019 | −1.6 | 1.3 |

Experiment 3 (D1 Polyurethane Dispersion in Ink)

| | | | | | | | | | |
|---|---|---|---|---|---|---|---|---|---|
| M2 | None | 1.002 | 0.764 | −23.8 | 11.7 | 1.001 | 0.907 | −9.4 | 3.9 |
| M2 | 0.75 dpp XL2 | 0.937 | 0.867 | −7.5 | 4.1 | 0.953 | 0.954 | −0.1 | 2.1 |
| M2 | 0.75 dpp XL3 | 0.941 | 0.837 | −11.1 | 4.8 | 0.948 | 0.929 | −2.0 | 2.1 |
| M2 | 0.75 dpp XL4 | 0.942 | 0.858 | −8.9 | 4.2 | 0.961 | 0.945 | −1.7 | 2.2 |
| M2 | 0.75 dpp XL5 | 0.959 | 0.852 | −11.2 | 5.1 | 0.959 | 0.924 | −3.6 | 2.8 |
| M2 | 0.75 dpp XL6 | 0.941 | 0.826 | −12.2 | 6.4 | 0.957 | 0.932 | −2.7 | 2.5 |
| M2 | 0.75 dpp XL7 | 0.965 | 0.852 | −11.7 | 6.2 | 0.970 | 0.943 | −2.8 | 2.8 |

Thus, the polyurethane particles evalulated perform quite well when curing at 80° C. In some instances, it may not be desirable to use temperatures as hot as 150° C., and thus, even at lower curing temperatures, the crosslinker can contribute to durability with ink compositions containing the polyurethane particles of the present disclosure.

### Example 9—Ink Composition Printability Performance

The Ink Compositions (M1 and M2) and the Crosslinker Compositions (XL1-XL7) were evaluated for performance from a thermal inkjet pen (A3410, available from HP, Inc.). The data was collected and shown in Table 4 below according to the following procedures:

Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value.

Drop Weight (DW) is an average drop weight in nanograms (ng) across the number of nozzles fired measured using a burst mode or firing.

Drop Weight 2,000 (DW 2K) is measured using a 2-drop mode of firing, firing 2,000 drops and then measuring/calculating the average ink composition drop weight in nanograms (ng).

Drop Volume (DV) refers to an average velocity of the drop as initially fired from the thermal inkjet nozzles.

Decel refers to the loss in drop velocity after 5 seconds of ink composition firing (Decel data was not collected for all Crosslinker Compositions).

Turn On Energy (TOE) Curve refers to the energy used to generate consistent ink composition firing at a drop weight (DW) threshold. Lower energy to achieve higher drop weights tend to be desirable, with DW increasing with increased energy and then flattening out as still more energy is applied.

TABLE 4
Thermal Inkjet Print Performance

| | | | | | | |
|---|---|---|---|---|---|---|
| | | | DW 2K | | | |
| Crosslinker ID or | % Missing | DW Drop | drop 30 | DV | | TOE |
| Ink ID | Nozzles | # KHz | KHz | (m/s) | Decel | Curve |

Experiment 1 (Crosslinker Compositions)

| | | | | | | |
|---|---|---|---|---|---|---|
| XL1 | 3.0 | 12.1 | 12.4 | 9.6 | — | Acceptable |
| (SV-02 / Glycerol) | | | | | | |
| XL2 | 3.0 | 11.7 | 12.4 | 9.6 | — | Acceptable |
| (SV-2 / 2P) | | | | | | |

Experiment 1 (Crosslinker Compositions)

| | | | | | | |
|---|---|---|---|---|---|---|
| XL2 | 2.1 | 12.3 | 12.9 | 11.8 | 0.0 | Good |
| (SV-2 / 2P) | | | | | | |
| XL3 | 6.3 | 6.1 | 9.8 | 8.9 | 0.5 | Acceptable |
| (V-02 / 2P) | | | | | | (Low DV |
| | | | | | | Low DV) |
| XL4 | 2.1 | 11.3 | 11.7 | 10.0 | 3.5 | Good |
| (V-02-L2 / 2P) | | | | | | |
| XL5 | 0.0 | 12.5 | 13.5 | 11.8 | 2.0 | Good |
| (E-02 / 2P) | | | | | | |
| XL6 | 5.2 | 11.1 | 11.7 | 9.0 | 3.4 | Acceptable |
| (XL-702 / 2P) | | | | | | (Low DV) |
| XL7 | 0.0 | 10.1 | 11.8 | 9.3 | 1.0 | Acceptable |
| (XL-732 / 2P) | | | | | | (Low DV) |

Experiment 3 (Ink Compositions)

| | | | | | | |
|---|---|---|---|---|---|---|
| M1 | 4.2 | 12 | 12.4 | 13.1 | 0 | Good |
| (D1 PU) | | | | | | |
| M2 | 70.8 | 12.4 | 13.1 | 13.6 | 0 | Good |
| (Impranil ® DLN-SD PU) | | | | | | |

As can be seen in Table 4, all of the crosslinker compositions and the polyurethane ink compositions showed reasonable or good print performance from a thermal inkjet printhead using varied testing protocols. Some of the ink compositions had good TOE Curve data and other had Acceptable TOE Curve data. TOE Curve data is considered Acceptable or Good when lower levels of energy are used to achieve higher drop weights (DW) as measured in nanograms (ng). For example, achieving a drop weight (DW) of 9.5 ng or above at an energy level 0.75 Joule may be considered “Good” TOE (with DW getting larger with more energy input until the curve flattens out). Achieving a drop weight (DW) of 5.0 ng or above at an energy level 0.75 Joule may be considered “Acceptable” TOE (with DW getting larger with more energy input until the curve flattens out). In further detail, however, lower drop weights (DW) below 9.5 ng or even below 5 ng at 0.75 Joules may provide for a “Good” TOE as long as the drop weights continue to get larger as the energy increases and then flatten out at an acceptable drop weight achieving a drop weight below 5.0 ng at an energy level of 0.75 Joule may be considered “Good” TOE (with DW getting larger with more energy input until the curve flattens out, as long as the drop weight is acceptable for inkjet printing applications).

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. A fluid set, comprising:
an ink composition, comprising:
water,
organic co-solvent,
pigment having dispersant associated with or attached thereto, and
from 0.5 wt % to 20 wt % of polymer binder particles selected from:
polyurethane particles including a polyurethane polymer with sulfonated amine groups, or
polyurethane-latex hybrid particles; and
a crosslinker composition, comprising:
water,
organic co-solvent, and
from 2 wt % to 10 wt % polycarbodiimide.

2. The fluid set of claim 1, wherein polyurethane particles are present and include nonionic diamine groups.

3. The fluid set of claim 1, wherein the polyurethane particles are present and have a weight average molecular weight from 30,000 Mw to 300,000 Mw, a D50 particle size from 20 nm to 300 nm, and an acid number from 0 mg KOH/g to 30 mg KOH/g.

4. The fluid set of claim 1, wherein the polyurethane particles are present and include isocyanate-generated amino groups.

5. The fluid set of claim 1, wherein the polyurethane particles or the polyurethane-latex hybrid particles are present and include polyester-type polyurethane polymer.

6. The fluid set of claim 1, wherein the polyurethane-latex hybrid particles are present and in a core-shell arrangement with a 5 wt % to 30 wt % polyurethane shell having an acid number from 50 mg KOH/g to 110 mg KOH/g, and a 70 wt % to 95 wt % (meth)acrylic latex polymer core having a glass transition temperature from −30° C. to 50° C., wherein weight percentages of the polyurethane-latex hybrid particles is based on a total weight of the hybrid particles.

7. The fluid set of claim 1, wherein the polycarbodiimide is present at from 3 wt % to 7 wt % in the crosslinker composition.

8. A textile printing system, comprising:
an ink composition, comprising:
water,
organic co-solvent,
pigment having dispersant associated with or attached thereto, and
from 0.5 wt % to 20 wt % of polymer binder particles selected from:
polyurethane particles including a polyurethane polymer with sulfonated amine groups, or
polyurethane-latex hybrid particles;
a crosslinker composition, comprising:
water,
organic co-solvent, and
from 2 wt % to 10 wt % polycarbodiimide; and
a fabric substrate.

9. The textile printing system of claim 8, wherein the polyurethane particles are present and further includes nonionic diamine groups.

10. The textile printing system of claim 8, wherein the polyurethane-latex hybrid particles are present and include sulfonated- or carboxylated-polyurethane.

11. The textile printing system of claim 8, wherein the polyurethane-latex hybrid particles are present in a core-shell arrangement with a 5 wt % to 30 wt % polyurethane shell having an acid number from 50 mg KOH/g to 110 mg KOH/g, and a 70 wt % to 95 wt % (meth)acrylic latex polymer core having a glass transition temperature from −30° C. to 50° C., wherein weight percentages of the polyurethane-latex hybrid particles is based on a total weight of the hybrid particles.

12. The textile printing system of claim 8, wherein the fabric substrate includes cotton, polyester, nylon, silk, or a blend thereof.

13. A method of textile printing, comprising separately ejecting i) an ink composition and ii) a crosslinker composition, wherein after ejecting, the ink composition and the crosslinker composition are in contact on a fabric substrate,
the ink composition, comprising:
water,
organic co-solvent,
pigment having dispersant associated with or attached thereto, and
from 0.5 wt % to 20 wt % of polymer binder particles selected from
polyurethane particles including a polyurethane polymer with sulfonated amine groups, or polyurethane-latex hybrid particles; and
the crosslinker composition, comprising:
water,
organic co-solvent, and
a polycarbodiimide,
wherein when in contact on the fabric substrate, the polycarbodiimide and the polymer binder particles are combined at a weight ratio from 1:99 to 3:7.

14. The method of claim 13, wherein the fabric substrate includes cotton, polyester, nylon, silk, or a blend thereof.

15. The method of claim 13, further comprising curing the ink composition contacted with the crosslinker composition on the fabric substrate at a temperature from 60° C. to 100° C. for from 30 seconds to 5 minutes.
